(19) United States
(12) Patent Application Publication
(10) Pub. No.: US 2025/0256631 A1
(43) Pub. Date: Aug. 14, 2025

(54) ARMREST ASSEMBLY

(71) Applicant: Jason May, Los Angeles, CA (US)

(72) Inventor: Jason May, Los Angeles, CA (US)

(21) Appl. No.: 18/442,009

(22) Filed: Feb. 14, 2024

(51) Int. Cl. B60N 2/75

(52) U.S. Cl. CPC B60N 2/753; B60N 2/78

(57) ABSTRACT

The present invention provides an armrest assembly for use in the shared armrest area between adjacent seats in a vehicle. The assembly provides two pivotable, vertically spaced armrest members, the assembly designed to replace the existing armrest without modification of the seat assembly. The vertical spacing of the armrests allows for one user to use the upper space while the other uses the lower space between the seats, affording both users full horizontal freedom of movement. The armrest members can be individually pivoted between the stowage and utility positions.

### BACKGROUND OF THE INVENTION

This invention relates generally to seating arrangements and more particularly to seating arrangements for commercial vehicles having seats arranged in rows.

### SUMMARY OF THE INVENTION

Riding in a commercial vessel such as a bus, plane, etc. can be an uncomfortable process. Particularly problematic is the shared armrest area between adjacent seats. Whether the shared armrest area has one large armrest or two relatively narrow armrests, users can wrest for control of the armrest which can result in disputes.

Prior art solutions to the problem typically involve separable narrow armrest elements which can be rotated, slid, or otherwise displaced. The displacement is typically horizontal which will tend to cause one arm of the user to be forced inward at an angle to use the armrest, the position being unnatural to most people.

The present invention overcomes the shortcomings of the prior art by taking advantage of the vertical space between the adjacent seats having a shared armrest. While there have been prior art shared armrest assemblies that use the vertical space (that is, with one person's arm positioned higher or lower than the others) these arrangements are stationary or non-adjustable and include a vertical wall between upper and lower rests. The vertical wall limits the horizontal arm movement of the passenger using the lower armrest, and is also uncomfortable as the lower armrest is enclosed on three sides.

The present invention provides an armrest assembly for use in the shared armrest area between adjacent seats in a vehicle. The assembly provides two pivotable, vertically spaced armrest members, the assembly designed to replace the existing armrest without modification of the seat assembly. The vertical spacing of the armrests allows for one user to use the upper space while the other uses the lower space between the seats, affording both users full horizontal freedom of movement. The armrest members can be individually pivoted between the stowage and utility positions.

It is an object of the invention to provide an armrest assembly for use in the shared armrest area between adjacent seats in a vehicle.

It is another object of the invention to provide an armrest assembly for use in the shared armrest area between adjacent seats in a vehicle which has vertically displaced armrest elements.

It is another object of the invention to provide an armrest assembly for use in the shared armrest area between adjacent seats in a vehicle which can be mounted in place of an existing armrest.

It is another object of the invention to provide an armrest assembly for use in the shared armrest area between adjacent seats in a vehicle which can be positioned in stowage and utility positions.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

### BRIEF DESCRIPTION OF DRAWINGS

FIG. 1 shows a perspective view of the armrest assembly with both arms in the lowered position.

FIG. 2 shows a perspective view of the top arm being moved into the raised position.

FIG. 3 shows a perspective view of the top arm being moved into the raised position.

FIG. 4 shows a perspective view of the top arm in the raised position.

FIG. 5 shows a perspective view of the lower arm being moved into the raised position.

FIG. 6 shows a perspective view of the assembly with both arms in the raised position.

FIG. 7 shows a perspective view of the assembly in use by two people at the same time.

FIG. 8 shows a perspective view of the assembly with both arms in the lowered position.

### DETAILED DESCRIPTION OF THE INVENTION

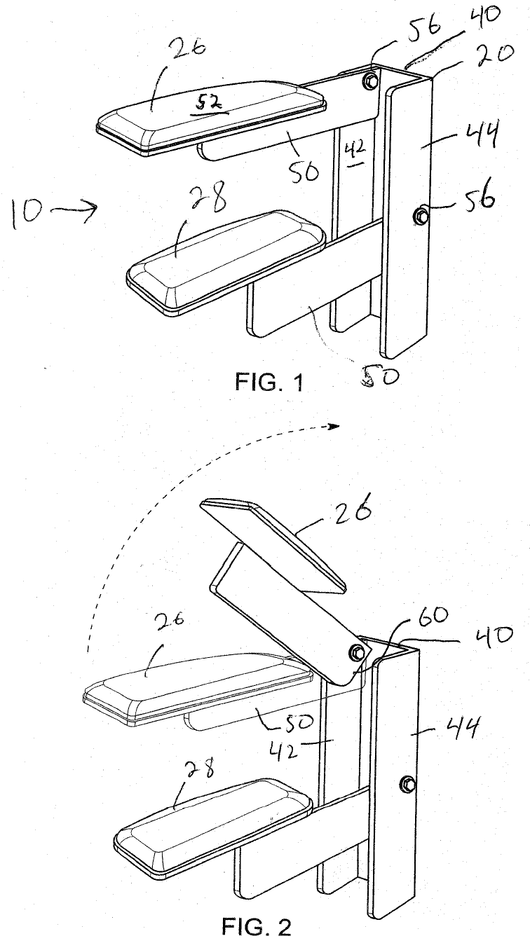

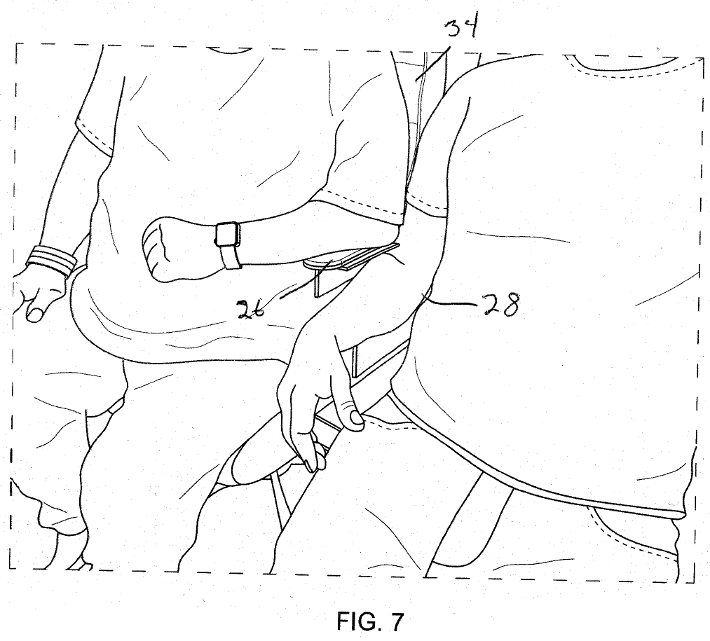

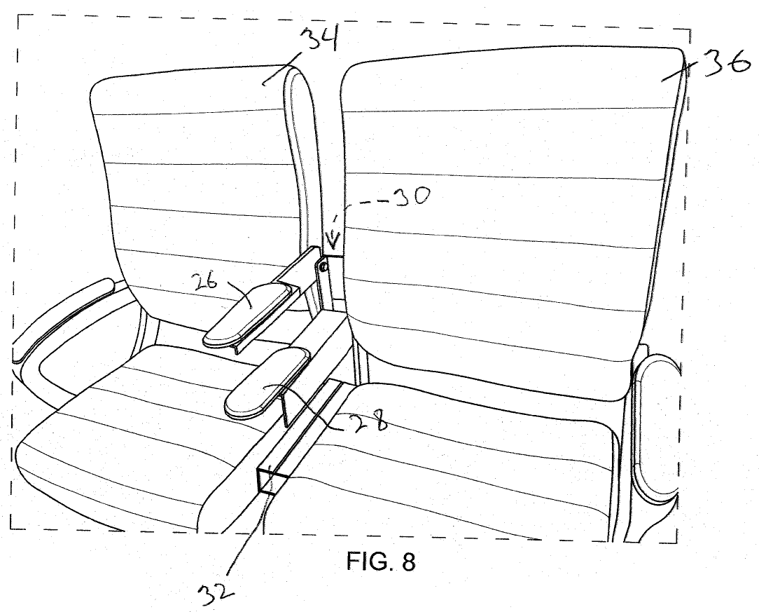

FIGS. 1-8 show various perspective views of the armrest assembly of the invention, generally indicated by the numeral 10. The assembly 10 has a vertically disposed mounting bracket 20 supporting two identical, vertically displaced armrest elements 26, 28. As can be seen in FIG. 8, the bracket 20 may be affixed to the seat frame 30 in the same position as a pre-existing armrest. Alternatively, a mounting assembly consisting of a horizontally displaced base 32 affixed between adjacent seats 34, 36 as by bolts, screws, etc., the base 32 (which may be pre-existing as part of the frame 30) serving as a mounting point for bracket 20 may be used. The base 32 has a hollow rectangular tube configuration to allow access to the fasteners (bolts, screws) used to secure the base. The base 32 and bracket 20 are preferably made of steel, with the base formed of suitably sized rectangular tube steel. While other means for securing the assembly 10 between adjacent seats may be apparent to one of skill in the art, it should be noted that the assembly 10 can typically be attached between seats in virtually any vehicle with little to no modification once the existing armrests are removed.

It can be seen that the mounting bracket 20 has a rear wall 40 and coextensive opposing sidewalls 42, 44. Rear wall 40 may include one or more bolt holes to allow connecting the assembly 10 in the manner described above. The sidewalls 42, 44 are necessarily horizontally displaced by the width of the rear wall 40 and are oriented to provide for the attachment of a pivotable connecting arm 50, the connecting arm being part of the armrest elements 26, 28. The connecting arms 50 may be attached to sidewalls 42, 44 pivotally in the well known manner, utilizing the preformed bolt holes 56.

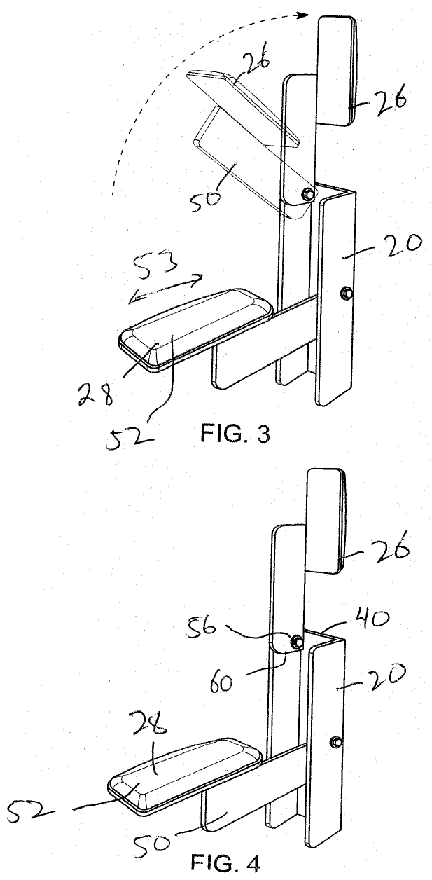

The armrest elements 26, 28 can be pivoted between utility and stowage positions. FIG. 1 shows the assembly 10 in the utility position, with both armrest elements 26, 28 in the horizontal position. The elements 26, 28 are maintained in the horizontal position by abutment of edge wall 60 of connecting arm 50 against the rear wall 40 of the mounting bracket 20. FIGS. 2-4 illustrate the upper element 26 being raised into the stowage position as per the directional arrows, the upper element 26 being vertical when in the stowage position. The armrest elements 26, 28 are held in the vertical position in the well known manner as by friction or other means to suppress free rotation of the connecting arms 50. Alternatively, the elements 26, 28 may be freely rotating with a locking means to secure them in a vertical position. Each element 26, 28 includes a resting pad 52 filled with foam or other compressible material. The rest of assembly 10 is preferably made of a metallic material like steel. The resting pads 52 may be slidably displaceable as shown by bidirectional arrow 53 in FIG. 3, the mechanism for this being apparent to one of skill in the art.

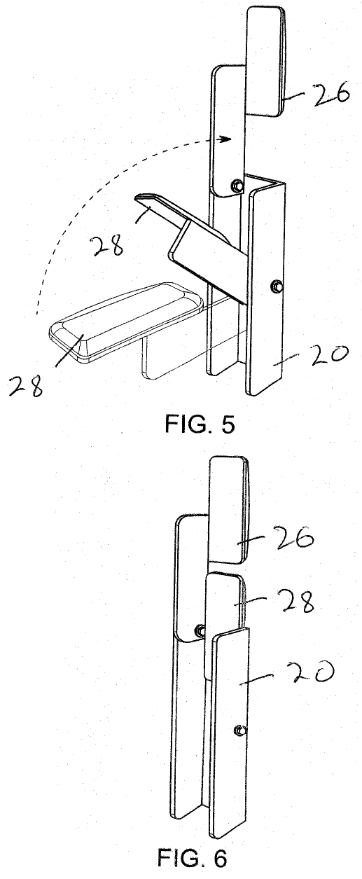

FIGS. 5 and 6 show the movement of lower armrest element 28 between utility and storage positions as per the arrow. When both elements 26, 28 are in the vertical position, the assembly is vertically oriented and completely out of the way of the passengers.

In operation, when the armrest elements 26, 28 are in the utility position, adjacent passengers may rest their arms on opposing pads 52. The elements 26, 28 are horizontally displaced by the width of the mounting bracket 20, so the passengers arms are not directly over each other. When not in use, one or both of the elements 26, 28 may rotated into the stowage position. While the invention is described in the context of adjacent vehicle seats, it can easily be adapted for use in any environment where adjacent seats are attached by a common frame or chassis.

1. An armrest assembly, the assembly positioned on or between adjacent seats connected by a common frame, the assembly comprising:
a mounting bracket, the bracket attached between said adjacent seats, the bracket having horizontally spaced co-extensive sidewalls extending forwardly therefrom;
upper and lower armrest elements, each of said upper and lower armrest elements pivotally attached to one of said sidewalls;
wherein each of said upper and lower armrest elements can be rotated between utility and stowage positions.

2. The assembly of claim 1 including a horizontal base attached to and secured between said adjacent seats wherein said bracket is attached to base.

3. The assembly of claim 2 wherein said horizontal base is formed of rectangular tube steel.

4. The assembly of claim 1 wherein each of said armrest elements has compressible material disposed on an upper surface.

5. The assembly of claim 1 wherein said adjacent seats have a pre-existing mounting structure, and said mounting bracket is attached to said structure.
